(19) United States
(12) Patent Application Publication
(10) Pub. No.: US 2025/0081143 A1
(43) Pub. Date: Mar. 6, 2025

(54) POSITIONING REQUESTS ACCORDING TO AN ORDER OF PREFERENCE

(71) Applicant: Nokia Technologies Oy, Espoo (FI)

(72) Inventors: Diomidis MICHALOPOULOS, Munich (DE); Osman Nuri Can YILMAZ, Helsinki (FI); Taylan SAHIN, Munich (DE); Oana-Elena BARBU, Aalborg (DK)

(21) Appl. No.: 18/291,169

(22) PCT Filed: Jul. 30, 2021
(86) PCT No.: PCT/EP2021/071466

§ 371 Date: Jan. 22, 2024

(51) Int. Cl. H04W 64/00

(52) U.S. Cl. CPC H04W 64/00

(57) ABSTRACT

A node apparatus comprising: at least one processor; and at least one memory including computer program code, the at least one memory and the computer program code configured to, with the at least one processor, cause the apparatus at least to perform: transmitting information indicative of a plurality of configurations for signals that enable positioning that can be undertaken by the network and an indication of an order of preference for the plurality of configurations.

### TECHNOLOGICAL FIELD

Examples of the disclosure relate to positioning requests. Some examples of the disclosure relate to User Equipment (UE) initiated positioning requests in New Radio (NR) networks.

### BACKGROUND

In radio communications networks such as NR networks UEs can initiate positioning requests. Examples of this disclosure provide for management of these requests.

### BRIEF SUMMARY

According to various, but not necessarily all, examples of the disclosure there is provided a node apparatus comprising:
at least one processor; and
at least one memory including computer program code, the at least one memory and the computer program code configured to, with the at least one processor, cause the apparatus at least to perform:
transmitting information indicative of a plurality of configurations for signals that enable positioning that can be undertaken by the network and an indication of an order of preference for the plurality of configurations.

The node apparatus may be configured to receive information indicative of a plurality of configurations for signals that enable positioning that can be undertaken by the network from a network apparatus configured to determine locations of one or more User Equipments (UEs).

The network apparatus may be configured to determine location of one or more UEs comprises a Location Management Function (LMF).

The node apparatus may be configured to receive a request indicating a plurality of configurations for signals that enable positioning that can be undertaken by the network from a network apparatus configured to determine locations of one or more User Equipments (UEs).

The node apparatus may be configured to receive information indicative of a plurality of configurations for signals that enable positioning that can be undertaken by the network in a positioning protocol message.

The information indicative of a plurality of configurations for signals that enable positioning that can be undertaken by the network may be transmitted by the node apparatus to one or more UEs.

The information indicative of a plurality of configurations for signals that enable positioning that can be undertaken by the network may be transmitted by the node apparatus using a Radio Resource Control (RRC) message.

The plurality of configurations for signals that enable positioning may comprise configurations that are available at the node apparatus and at one or more neighbouring node apparatus.

The plurality of configurations for signals that enable positioning may be determined based on data provided by the node apparatus and one or more neighbouring node apparatus.

The order of preference of the plurality of configurations for signals that enable positioning may be configured so as to substantially optimise efficiency of network resources.

The information indicative of a plurality of configurations for signals that enable positioning that can be undertaken by the network and an indication of an order of preference for the plurality of configurations may be transmitted at regular intervals.

The information indicative of a plurality of configurations for signals that enable positioning that can be undertaken by the network and an indication of an order of preference for the plurality of configurations may be transmitted in response to a trigger event.

The plurality of configurations for signals that enable positioning that can be undertaken by the network may be specific to a subset of UEs.

The configurations for signals that enable positioning may comprise Positioning Reference Signal (PRS) configurations.

According to various, but not necessarily all, examples of the disclosure there is provided a node apparatus comprising means for:

transmitting information indicative of a plurality of configurations for signals that enable positioning that can be undertaken by the network and an indication of an order of preference for the plurality of configurations.

According to various, but not necessarily all, examples of the disclosure there is provided a method comprising:
transmitting information indicative of a plurality of configurations for signals that enable positioning that can be undertaken by a network and an indication of an order of preference for the plurality of configurations.

According to various, but not necessarily all, examples of the disclosure there is provided a computer program comprising computer program instructions that, when executed by processing circuitry, cause:
transmitting information indicative of a plurality of configurations for signals that enable positioning that can be undertaken by a network and an indication of an order of preference for the plurality of configurations.

According to various, but not necessarily all, examples of the disclosure there is provided a User Equipment (UE) comprising;
at least one processor; and
at least one memory including computer program code the at least one memory and the computer program code configured to, with the at least one processor, cause the UE at least to perform:
obtaining a plurality of configurations for signals that enable positioning that can be undertaken by a network;
obtaining an indication of an order of preference for the plurality of configurations; and
transmitting one or more requests to a network indicating at least some of the plurality of configurations for signals that enable positioning and the order of preference for the plurality of configurations.

The requests to the node apparatus may comprise a reason for each of the plurality of configurations included in the request.

The UE may obtain information indicative of the plurality of configurations for signals that enable positioning that can be undertaken by the network from at least one of: a node apparatus, a network apparatus.

The one or more requests may be adapted based on data received from the network.

The UE may generate a list of the plurality of configurations for signals that enable positioning that can be undertaken by the network and the order of preference for the plurality of configurations.

According to various, but not necessarily all, examples of the disclosure there is provided a User Equipment (UE) comprising means for:
obtaining a plurality of configurations for signals that enable positioning that can be undertaken by a network;
obtaining an indication of an order of preference for the plurality of configurations; and
transmitting one or more requests to a network indicating at least some of the plurality of configurations for signals that enable positioning and the order of preference for the plurality of configurations.

According to various, but not necessarily all, examples of the disclosure there is provided a method comprising:
obtaining a plurality of configurations for signals that enable positioning that can be undertaken by a network;
obtaining an indication of an order of preference for the plurality of configurations; and
transmitting one or more requests to a network indicating at least some of the plurality of configurations for signals that enable positioning and the order of preference for the plurality of configurations.

According to various, but not necessarily all, examples of the disclosure there is provided a computer program comprising computer program instructions that, when executed by processing circuitry, cause:
obtaining a plurality of configurations for signals that enable positioning that can be undertaken by a network;
obtaining an indication of an order of preference for the plurality of configurations; and
transmitting one or more requests to a network indicating at least some of the plurality of configurations for signals that enable positioning and the order of preference for the plurality of configurations.

According to various, but not necessarily all, examples of the disclosure there is provided a network apparatus comprising:
at least one processor; and
at least one memory including computer program code,
the at least one memory and the computer program code configured to, with the at least one processor, cause the apparatus at least to perform:
transmitting information indicative of a plurality of configurations for signals that enable positioning that can be undertaken by the network and an indication of an order of preference for the plurality of configurations for signals that enable positioning.

The network apparatus may receive, from a plurality of node apparatus, data indicative of configurations for signals that enable positioning undertaken by the node apparatus and uses the data indicative of configurations for signals that enable positioning undertaken by the node apparatus to determine the plurality of configurations for signals that enable positioning that can be undertaken by the network and the order of preference for the plurality of configurations for signals that enable positioning.

The network apparatus may be configured to receive one or more positioning requests from one or more UEs wherein the positioning request indicating at least some of the plurality of configurations for signals that enable positioning and the order of preference for the plurality of configurations.

The received positioning request may comprise a reason for each of the plurality of configurations included in the request.

The information indicative of a plurality of configurations for signals that enable positioning that can be undertaken by the network and an indication of an order of preference for the plurality of configurations for signals that enable positioning may be transmitted to one or more node apparatus and/or one or more UEs.

The network apparatus may be configured to determine locations of one or more UEs.

The network apparatus may comprise a Location Management Function (LMF).

According to various, but not necessarily all, examples of the disclosure there is provided a network apparatus comprising means for:
transmitting information indicative of a plurality of configurations for signals that enable positioning that can be undertaken by the network and an indication of an order of preference for the plurality of configurations for signals that enable positioning.

According to various, but not necessarily all, examples of the disclosure there is provided a method comprising:
transmitting information indicative of a plurality of configurations for signals that enable positioning that can be undertaken by the network and an indication of an order of preference for the plurality of configurations for signals that enable positioning.

According to various, but not necessarily all, examples of the disclosure there is provided a computer program comprising computer program instructions that, when executed by processing circuitry, cause:
transmitting information indicative of a plurality of configurations for signals that enable positioning that can be undertaken by the network and an indication of an order of preference for the plurality of configurations for signals that enable positioning.

### BRIEF DESCRIPTION

Some examples will now be described with reference to the accompanying drawings in which:

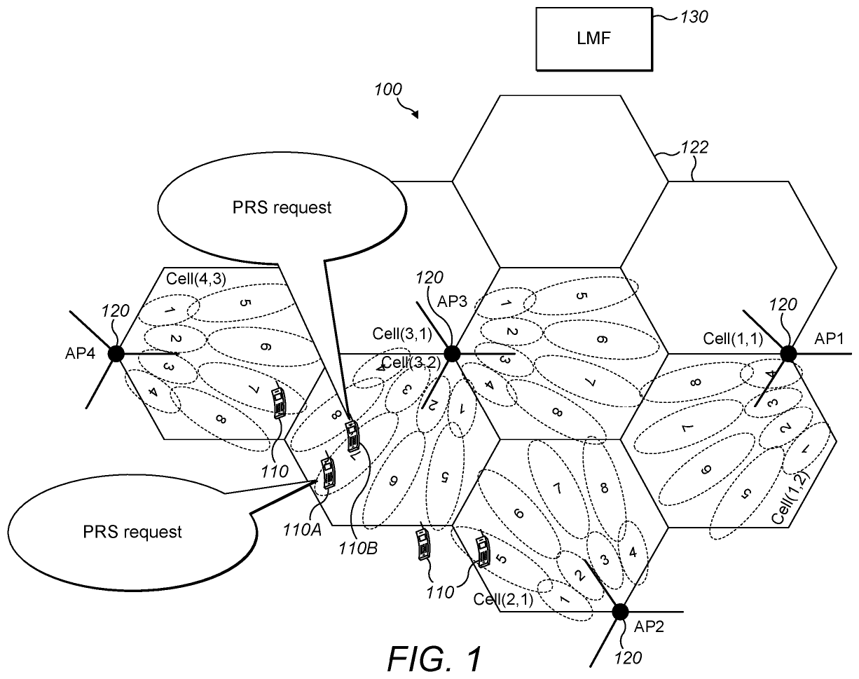

FIG. 1 shows an example of the subject matter described herein;

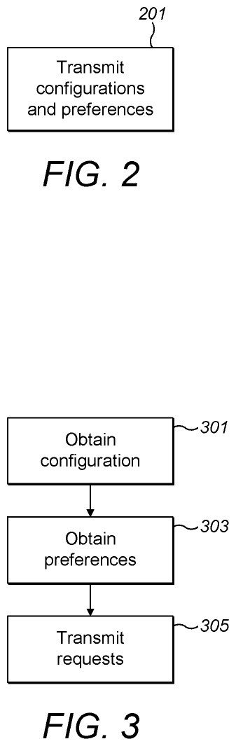

FIG. 2 shows another example of the subject matter described herein;

FIG. 3 shows another example of the subject matter described herein;

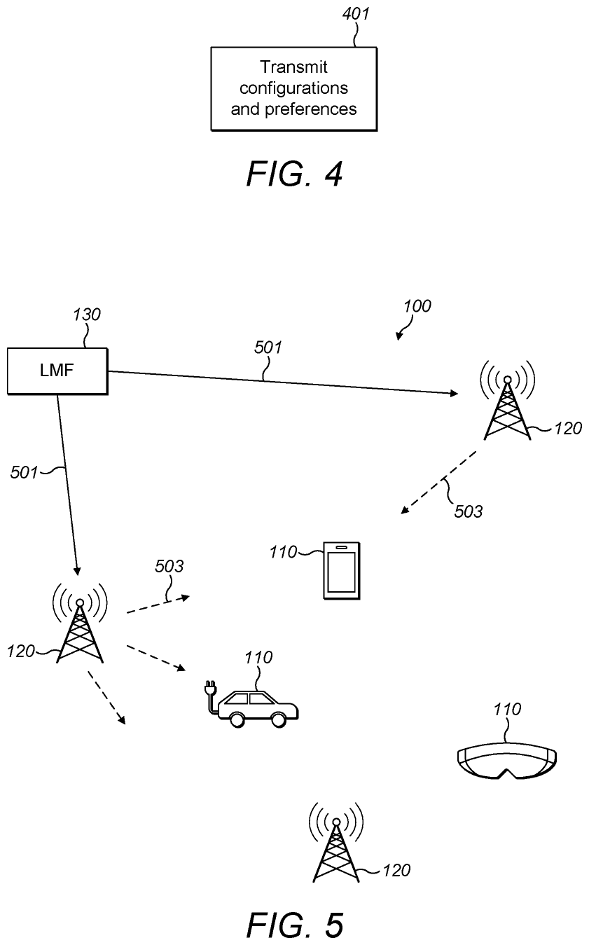

FIG. 4 shows another example of the subject matter described herein;

FIG. 5 shows another example of the subject matter described herein;

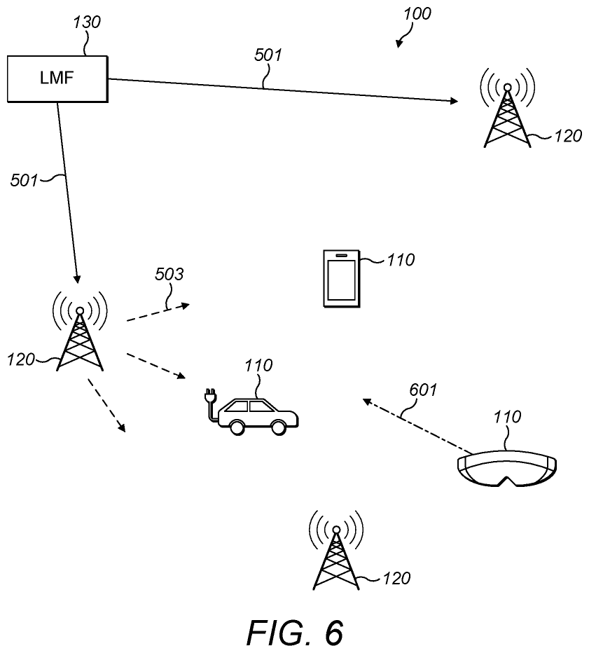

FIG. 6 shows another example of the subject matter described herein; and

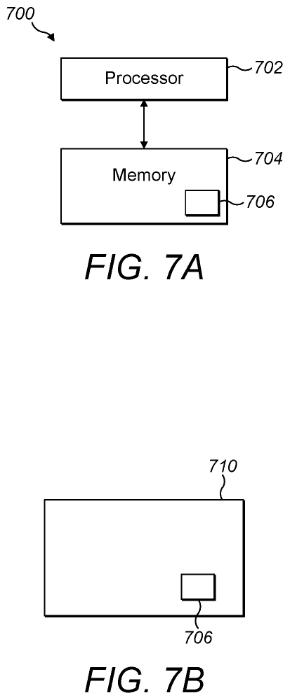

FIGS. 7A and 7B show another example of the subject matter described herein.

### Definitions

gNB NR base station
LMF Location Management Function
LPP LTE Positioning Protocol
LTE Long Term Evolution
NAS Non Access Stratum
NR New (5G) Radio
NRPPa New Radio Positioning Protocol a
ODPRS On-Demand PRS
PRS Positioning Reference Signal
QoS Quality of Service
RAN Radio Access Network
RRC Radio Resource Control
SIM Subscriber Identity Module
SNR Signal to Noise Ratio
UE User Equipment
URLLC Ultra Reliability Low Latency

### DETAILED DESCRIPTION

FIG. 1 illustrates an example of a network 100 comprising a plurality of network entities including terminal apparatus 110, node apparatus 120 and one or more network apparatus 130. The terminal apparatus 110 and node apparatus 120 communicate with each other. The one or more network apparatus 130 communicate with the access nodes 120. In some examples the one or more network apparatus 130 communicate with the terminal apparatus 110.

The one or more network apparatus 130 can, in some examples, communicate with each other. The one or more node apparatus 120 can, in some examples, communicate with each other.

The network 100 can be a cellular network comprising a plurality of cells 122 each served by a node apparatus 120. In this example, the interface between the terminal apparatus 110 and a node apparatus 120 defining a cell 122 is a wireless interface.

The node apparatus 120 comprises a cellular radio transceiver. The terminal apparatus 110 comprises a cellular radio transceiver.

In the example illustrated the cellular network 100 is a third generation Partnership Project (3GPP) network in which the terminal apparatus 110 are user equipment (UE) and the node apparatus 120 can be access nodes such as base stations.

The term ‘user equipment’ is used to designate mobile equipment comprising a smart card for authentication/encryption etc such as a subscriber identity module (SIM). In other examples the term ‘user equipment’ is used to designate mobile equipment comprising circuitry embedded as part of the user equipment for authentication/encryption such as software SIM.

The node apparatus 120 can be any suitable base station. A base station is an access node. It can be a network element in radio access network responsible for radio transmission and reception in one or more cells to or from the user equipment.

The network 100 can be a 4G or 5G network, for example. It can for example be a New Radio (NR) network that uses gNB or eNB as access nodes 120. New radio is the 3GPP name for 5G technology.

Such networks 100 can also comprise next generation mobile and communication network, for example, a 6G network.

The node apparatus 120 can be configured to transmit signals such as Positioning Reference Signals (PRS) to UEs within the network 100. The UE 110 can receive and process the PRS, or any other suitable signals, to derive the location of the UE 110. The location of the UE 110 can be derived by the UE (UE-based positioning) or can be derived by one or more network apparatus 130 after the UE 110 has provided measurements to the one or more network apparatus 130 (UE-assisted positioning).

In order to enable On-Demand PRS (ODPRS) stronger reception of PRS signals by the UE 110 may be needed. The stronger reception can enable higher accuracy of the positioning. If this is needed then the network 100 can provide increased PRS resources. The increased PRS resources can comprise increased bandwidth and/or increased number of occasions for PRS. The increased PRS resources can be provided for designated areas or designated subsections of the network 100.

The PRS resources can be transmitted by the node apparatus 120 in different beams. The beams can be directed towards the UEs 110.

In the example shown in FIG. 1 a plurality of UEs 110 are within an area associated with an active positioning session. In this positioning session a plurality of UEs 110 have made a positioning request such as an ODPRS.

The ODPRS request is transmitted from the UE 110 to the network apparatus 130. The network apparatus 130 can be any apparatus configured to determine a location of a UE 110. The network apparatus 130 can be a location management function (LMF) or any other suitable network apparatus 130.

The network apparatus 130 can be configured to request the PRS resources from the node apparatus 120. If the ODPRS request is accepted by the network 100 (that is, the network apparatus 130 and the node apparatus 120), then the UE 110 is able to measure and report the respective PRS. If the ODPRS request is not accepted by the network 100 then the UE needs to instigate another ODPRS request to the network 100.

The network 100 might not be able to satisfy every ODPRS request it receives from the UEs 110. For example, if the resources requested for ODPRS are used for other purposes or if there are resource conflicts with other ongoing positioning sessions in the same cell 122 and/or same area with neighbouring node apparatus 120 overlap, then the network 100 might not be able to satisfy the request. The other purposes that the resources are being used for could be high priority services such as ultra reliability low latency (URLLC) services, or any other suitable services.

In the example shown in FIG. 1 some of the beams transmitted by the node apparatus 120 are used to convey PRS transmissions while other beams are not used to convey PRS transmissions. In this example a first UE 110A and a second UE 110B are located within the same coverage area. The same beam is directed towards both the first UE 110A and the second UE 110B.

In this example the first UE 110A makes a request for PRS resources while the second UE 110B is currently using those PRS resources. Because there is more than one UE 110 requesting the same PRS resources the request made by the first UE 110A will be refused.

The network 100 could also refuse a request for PRS resource in other circumstances. For instance, the network 100 might not be able to allocate PRS resources to the first UE 110 because the network 100 might have another transmission scheduled for the requested beam or resource.

Therefore, when a UE 110 requests PRS resources it is not guaranteed that the network 100 will accept the request. To take this into account the UE 110 may be configured to instigate additional requests for PRS resources until a PRS resource request is satisfied. This can lead to latency implications. Examples of this disclosure address this issue and provide for a network 100 in which the probability of a UE 110 request for PRS resources will be undertaken is improved. This can reduce the latency issues and provide for an optimized, or substantially optimized, latency.

FIG. 2 shows an example method that can be implemented using examples of the disclosure. This method could be implemented by a node apparatus 120 such as a gNB.

The method comprises, at block 201, transmitting information indicative of a plurality of configurations for signals that enable positioning that can be undertaken by the network 100. The information is transmitted with an indication of an order of preference for the plurality of configurations.

The configurations can refer to the time and frequency allocation of the positioning resources, patterns of the transmissions of the positioning signals such as duration and periodicity, and any other suitable information.

The configurations for signals that enable positioning can comprise PRS configurations and/or any other suitable configurations. The method therefore enables a node apparatus 120 to announce the PRS configurations that can be undertaken in response to ODPRS requests. The method therefore enables the network 100 to proactively announce PRS configurations that the network 100 is able to undertake in the event that a UE 110 instigates UE-initiated ODPRS request at a future time, and in case the current PRS configurations cannot satisfy the needs of the UE 110.

Before the node apparatus 120 transmits the information indicative of a plurality of configurations that can be undertaken by the network 100 this information can be received from a network apparatus 130 or any other suitable entity. The network apparatus 130 that provides the information to the node apparatus 120 can be a network apparatus configured to determine locations of one or more UE such as an LMF or any other suitable apparatus.

The network apparatus 130 can be configured to collect information relating to the configurations from the node apparatus 120 and from one or more neighbouring node apparatus 120. The network apparatus 130 can be configured to collect information relating to the configurations that are currently in use at the node apparatus 120 and neighbouring node apparatus, the most recently used configurations for the node apparatus 120 and neighbouring node apparatus 120, configurations for the node apparatus 120 and neighbouring node apparatus 120 that could be used at a future time and/or information relating to any other suitable alternative configurations.

The node apparatus 120 that are comprised within the set of neighbouring node apparatus 120 can be determined by the network apparatus 130 or by any other suitable entity. In some examples the neighbouring node apparatus 120 can comprise non-serving node apparatus 120. In some examples the neighbouring node apparatus 120 can be in adjacent cells 122 or in cells 122 that are further away from the serving node apparatus 120.

In some examples once the network apparatus 130 has collected information relating to the configurations from the node apparatus 120 and from one or more neighbouring node apparatus 120 then the network apparatus 130 determine an order of preference for the configurations and can transmit that information to the node apparatus 120. In some examples the network apparatus 130 could transmit the information relating to the available configurations to the node apparatus 120 and the node apparatus 120 could determine the order of preference for the configurations.

The order of preference can be configured so as to optimise, or substantially optimise, efficiency of network resources or to satisfy any other suitable criteria.

In some examples configurations that are currently in use at the node apparatus 120 can be assigned the highest preference levels. The remaining alternative configurations could be assigned preference levels based on their requirements for network resources. Other methods for assigning preferences could be used in other examples.

The information can be received by the node apparatus 120 in any suitable message. In some examples the information can be received in a positioning protocol message such as an NRPPa message.

The node apparatus 120 can transmit the information to one or more UEs 110. The node apparatus can transmit the information in one or more beamformed signals. The beamformed signals can be directed towards the one or more UEs 110.

The node apparatus 120 can transmit the information to one or more UEs 110 using any suitable message such as a Radio Resource Control (RRC) message.

The information relating to the available configurations and the order of preference can be transmitted in any suitable format. In some examples the information could be transmitted as a list or table which records each of the available configurations and an assigned preference level. In other examples the information could be transmitted as a differential. Instead of providing the information for each configuration the difference between the respective configurations, and the assigned order of preference, could be transmitted instead.

The method shown in FIG. 2 can be repeated as appropriate. In some examples the method can be repeated so that the information indicating the configurations and their order of preference is transmitted at regular intervals. In some examples the information indicating the configurations and their order of preference can be transmitted in response to a trigger event. The trigger event could be a new UE 110 connect to a cell 122, when a UE 110 requirement changes, a change in status of a UE 110 (such as a change in RRC state from connected to inactive), an update becoming available, or any other suitable trigger event.

In some examples the information indicating the configurations and their order of preference can be generic for all UEs 110 within an area. In other examples the configurations and their order of preference can be specific to a subset of UEs 110. The subset could be determined based on location, slice preferences, UE category, positioning requirement or any other suitable criteria. In some cases the information relating to the configurations and the order of preference might only be available for the subset of UEs 110.

FIG. 3 shows an example method that can be implemented using examples of the disclosure. This method could be implemented by a terminal apparatus 110 such as a UE 110.

The method comprises, at block 301, obtaining a plurality of configurations for signals that enable positioning that can be undertaken by a network 100.

The configurations for signals that enable positioning can comprise PRS configurations and/or any other suitable configurations.

In some examples the UE 110 obtains the information relating to the configurations by receiving relevant information from the network 100. In some examples the information can be received from a node apparatus 120, a network apparatus 130 or any other suitable type of apparatus.

The information can be transmitted to the UE 110 using any suitable type of message. If the information is transmitted from a node apparatus 120 to the UE 110 the information could be transmitted using an RRC message or any other suitable type of message. If the information is transmitted from a network apparatus 130 to the UE 110 the information could be transmitted using an LTE Positioning Protocol (LPP) message or any other suitable type of message.

At block 303 the method comprises obtaining an indication of an order of preference for the plurality of configurations.

In some examples the order of preference of the configurations could be determined by the network 100 and transmitted to the UE 110 with the information relating to the configurations. In such examples the information relating to the configurations and the associated order of preference could be transmitted in the same message.

In other examples the UE 110 could be configured to generate the order of preference. In such examples the UE 110 could receive the information relating to the available configurations from the network 100 and could use that information to create an order of preference. The order of preference could be generated so as to optimise, or substantially optimise, use of network resources or to satisfy any other suitable criteria.

At block 305 the method comprises transmitting one or more requests to the network 100. The requests could be transmitted to the node apparatus 120 and/or to a network apparatus 130.

The requests can be positioning requests, requests for PRS resources ODPRS requests or any other suitable requests. The requests can indicate at least some of the plurality of configurations for signals that enable positioning and the order of preference for the plurality of configurations.

The request could be sent using any suitable messages. For instance, in some example the request could be a UE-initiated ODPRS request that is enabled by enhancing an LPP RequestAssistanceData message.

The requests can be sent in response to a trigger event. The trigger event could be a change in the radio conditions of the UE 110, a change in the positioning Quality of Service (QOS) requirements for the UE 100 or any other suitable event.

In some examples the request can also comprise a reason for each of the plurality of configurations included in the request. The reasons could be a QoS for positioning, radio conditions, UE capability, UE status or any other suitable reason. As an example, a UE 110 might request a PRS configuration with larger bandwidth due to a high accuracy requirement, or a UE 110 might request a larger power PRS due to increased path loss. In some examples, less frequent PRS might be requested due to the UE 110 having low energy/power.

In some examples the requests can be adapted based on data received from the network 100. For example, if the UE 110 receives further information indicative of the configurations and alternative configurations then the requests and the configuration and order of preference listed in the requests can be adapted. This can enable the UE 110 to minimise, or substantially minimise, the probability that a request is rejected. The requests that are sent by the UE 110 comprise configurations that have been previously announced by the network 100 and/or configurations selected based on consideration of ongoing (currently active) configurations.

FIG. 4 shows an example method that can be implemented using examples of the disclosure. This method could be implemented by a network apparatus 130 such as an LMF. In some examples the network apparatus 130 could comprise a Radio Access Network (RAN) local entity, or any other suitable network entity. The network apparatus 130 could be any network apparatus 130 that supports location determination for a UE 110. The network apparatus 130 can be configured coordinate dynamic PRS configurations within an area of a network 100. In some examples the network apparatus 130 could be co-located within a node apparatus 120. In some examples the network apparatus 130 could share, or partially share, functionalities with one or more node apparatus 120.

The method comprises, at block 401, transmitting information indicative of a plurality of configurations for signals that enable positioning that can be undertaken by the network 100. The information is transmitted with an indication of an order of preference for the plurality of configurations.

The configurations for signals that enable positioning can comprise PRS configurations and/or any other suitable configurations.

The information can be transmitted to one or more node apparatus 120 to enable the node apparatus 120 to broadcast the information or otherwise transmit the information to the UEs in the network 100. In other examples the information can be sent from the network apparatus 130 to the UEs 110.

The information can be transmitted to one or more node apparatus 120 within a given area. The given area can be a geographical area. The given area can be an area for which the network apparatus 130 coordinates the dynamic PRS configurations.

The network apparatus 130 can be configured to determine the configurations that are available before they are transmitted. The configurations that are available can comprise the configurations that are used at the node apparatus 120 and also configurations that are currently in use at one or more neighbouring node apparatus 120. The network apparatus 130 can determine the configurations that are available based on data received from the node apparatus 120 and from one or more neighbouring node apparatus 120. This data could comprise the configurations currently in use at the node apparatus and/or any other suitable information.

In some examples the network apparatus 130 can also be configured to determine the order of preference for the plurality of configurations. The order of preference for the configurations can also be determined based on information received from one or more node apparatus 120. The order of preference can be configured so as to optimise, or substantially optimise, efficiency of network resources or to satisfy any other suitable criteria. In this instance efficiency of network resources refers to the level of reuse of PRS resources. That is, the same PRS can be used for find the position of multiple UEs 110 at the same time.

In other examples the network 100 can be configured so that the node apparatus 120 or the UEs 110 can determine the order of preference for the configurations.

The method shown in FIG. 4 can be repeated as appropriate. In some examples the method can be repeated so that the information indicating the configurations is transmitted at regular intervals. In some examples the information indicating the configurations can be transmitted in response to a trigger event. The trigger event could be a change in the configurations for one or more the node apparatus 120 or any other suitable event.

In some examples the network apparatus 130 can also be configured to receive one or more positioning requests, request for PRS resources UE-initiated ODPRS requests or other suitable requests. The request can be received from one or more UEs 110. These requests can comprise indications of at least some of the plurality of configurations and order of preference for the plurality of configurations. In some examples the requests can also comprise one or more reasons for each of the plurality of configurations included in the request and the assigned order of preference.

The requests from the UEs 110 can be received after the information indicating the configurations has bene transmitted by the network apparatus 130 and/or node apparatus 120. The UE 110 can therefore use the information transmitted by the network apparatus 130 and/or node apparatus 120 to make an informed positioning request.

FIG. 5 shows an example embodiment. In this example the network 100 comprises a network apparatus 130, a plurality of node apparatus 120 and a plurality of UEs 110. In this example the UEs 110 comprise a mobile phone, a vehicle and a headset. Other types of UE 110 could be used in other examples of the disclosure.

In this example the network apparatus 130 is configured to collect information relating to PRS configurations of the node apparatus 120. The network apparatus 130 then transmits a signal 501 indicating the PRS configurations of the plurality of the node apparatus 120. This enables each node apparatus 120 to receive notification of the PRS configurations currently in use and also the PRS configurations used by neighbouring node apparatus 120. The PRS configurations used by neighbouring node apparatus 120 provide alternative PRS configurations.

The node apparatus 120 can then determine the plurality of PRS configurations that are available. That is, from the information indicative of the PRS configurations of the neighbouring node apparatus 120 the node apparatus 120 can determine which configurations it can undertake.

In addition to determining the PRS configurations that can be undertaken the node apparatus 120 can also determine an order of preference for the available PRS configurations. For instance, the highest level of preference could be assigned to the PRS configurations currently in use. The remaining alternative PRS configurations could be ranked in an order based on the amount of network resources they use or any other suitable criteria.

The information indicating the available PRS configurations and their order of preference can be transmitted to the UEs 110 within the network 100 using signal 503. In the example of FIG. 5 the information is broadcast by the node apparatus 120. In other examples the information could be unicast. For example, the network 100 could instigate Non-Access Stratum (NAS) unicast LPP transferring of the configurations for the area of interest to the UEs 110 within that area.

In some examples when the UE 110 makes the UE-initiated ODPRS request it can also include one or more reasons for requesting alternative PRS configurations. The reasons could be QoS requirements, a need for higher accuracy or any other suitable requirements.

The UEs 110 can receive the information indicating the available PRS configurations and their order of preference. When the UE 110 makes a UE-initiated ODPRS request the UE 110 can select a PRS configuration from the list of available PRS configurations. The UE 110 can make this selection based on the order of preference given. This makes it more likely that the ODPRS request can be undertaken and will reduce latency issues within the positioning request. The latency can be measured by the time between the UE 110 instigating a UE-initiated ODPRS request and the UE 110 receiving an indication to measure the configured PRS.

FIG. 6 shows another example.

In this example the network apparatus 130 is configured to collect information relating to PRS configurations of the node apparatus 120. The network apparatus 130 then transmits a signal 501 indicating the PRS configurations of the plurality of the node apparatus 120. This enables each node apparatus 120 to receive notification of the PRS configurations currently in use and also the PRS configurations used by neighbouring node apparatus 120. The PRS configurations used by neighbouring node apparatus 120 provide alternative PRS configurations.

The node apparatus 120 can then transmit a signal 503 indicating the PRS configurations of the plurality of the node apparatus 120. This signal 503 can comprise information indicating the PRS configurations currently used by the node apparatus 120 as well as one or more alternative PRS configurations. The alternative PRS configurations can comprise the PRS configurations that are in use at the neighbouring node apparatus 120.

The UE 110 receives the information indicating the plurality of PRS configurations and can use this information to generate an ODPRS request 601 indicating a plurality of PRS configurations. The UE 110 can use the information received to determine which PRS configurations can be used and determine an order of preference of the PRS configurations. The ODPRS request 601 can then contain an indication of these PRS configurations and the order for the preference.

In these examples the request can also contain reasons for the order of preference. The reasons could be due to low signal strength, a higher accuracy requirement or any other suitable reason.

In the example of FIG. 6 the request made by the UE 110 does not need to include all of the alternative PRS configurations that have been indicated by the node apparatus 120. In some examples the request made by the UE 110 can indicate just a subset of the PRS configurations indicated by the node apparatus 120. The UE 110 can limit the request to include only the PRS configurations that are suitable for the UE 110 and can disregard the other PRS configurations.

In some examples only a single PRS configuration could be determined to be suitable by the UE 110. In such cases the order of preference can comprise a null. This can indicate that there are no suitable alternative PRS configurations. If there are no alternative PRS configurations then a reason for this can also be provided within the request.

The order of preference of the PRS configurations can be indicated by the UE 110 using any suitable notations. In some examples the UE 110 can use a predefined index value to refer to an alternative PRS configurations or a specific order of PRS configurations. This can reduce the message overhead. The predefined index can be defined by the network apparatus 130 or by any other suitable entity. For example, a mapping between the reasons and an index or indicator can be as given in the following table:

| Cause | Indicator |
|---|---|
| high Accuracy | 0 |
| low SNR | 1 |
| very low SNR | 2 |

The reasons for the order of preference of the PRS configurations and the criteria for defining the reasons can be predefined by the network 100, the operator, a specification or any other suitable entity. For instance, the threshold value for defining a low signal strength can be predefined. In some examples such threshold values can be dependent on the positioning service requirement dictated by a specific use case or application. The cause can be indicated by the UE 110 via a predefined index value.

The use of the alternative configurations and their order of preference and the reasons for the order makes it more likely that the ODPRS request can be undertaken by the network 100. This will reduce latency issues within the ODPRS request.

FIG. 7A illustrates an example of a controller 700. The controller 700 could be provided within an apparatus such as a UE 110 or a network apparatus 130 or a node apparatus 120. Implementation of a controller 700 can be as controller circuitry. The controller 700 can be implemented in hardware alone, have certain aspects in software including firmware alone or can be a combination of hardware and software (including firmware).

As illustrated in FIG. 7A the controller 700 can be implemented using instructions that enable hardware functionality, for example, by using executable instructions of a computer program 706 in a general-purpose or special-purpose processor 702 that may be stored on a computer readable storage medium (disk, memory etc) to be executed by such a processor 702.

The processor 702 is configured to read from and write to the memory 704. The processor 702 may also comprise an output interface via which data and/or commands are output by the processor 702 and an input interface via which data and/or commands are input to the processor 702.

The memory 704 stores a computer program 706 comprising computer program instructions (computer program code) that controls the operation of the apparatus when loaded into the processor 702. The computer program instructions, of the computer program 706, provide the logic and routines that enables the apparatus to perform the methods illustrated in FIGS. 2 to 4 The processor 702 by reading the memory 704 is able to load and execute the computer program 706.

In examples where the apparatus is provided within a node apparatus 120 the apparatus therefore comprises: at least one processor; and at least one memory including computer program code; the at least one memory and the computer program code configured to, with the at least one processor, cause the apparatus at least to perform;
transmitting information indicative of a plurality of configurations for signals that enable positioning that can be undertaken by the network and an indication of an order of preference for the plurality of configurations.

In examples where the apparatus is provided within a UE 110 the apparatus therefore comprises: at least one processor; and at least one memory including computer program code; the at least one memory and the computer program code configured to, with the at least one processor, cause the apparatus at least to perform;
obtaining a plurality of configurations for signals that enable positioning that can be undertaken by a network;
obtaining an indication of an order of preference for the plurality of configurations; and
transmitting one or more requests to a network indicating at least some of the plurality of configurations for signals that enable positioning and the order of preference for the plurality of configurations.

In examples where the apparatus is provided within a network apparatus 130 the apparatus therefore comprises: at least one processor; and at least one memory including computer program code; the at least one memory and the computer program code configured to, with the at least one processor, cause the apparatus at least to perform;
transmitting information indicative of a plurality of configurations for signals that enable positioning that can be undertaken by the network and an indication of an order of preference for the plurality of configurations for signals that enable positioning.

As illustrated in FIG. 7B, the computer program 706 may arrive at the apparatus or network apparatus via any suitable delivery mechanism 710. The delivery mechanism 710 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 706. The delivery mechanism may be a signal configured to reliably transfer the computer program 706. The apparatus may propagate or transmit the computer program 706 as a computer data signal.

Computer program instructions for causing a node apparatus 120 to perform at least the following or for performing at least the following:
transmitting information indicative of a plurality of configurations for signals that enable positioning that can be undertaken by the network and an indication of an order of preference for the plurality of configurations.

Computer program instructions for causing a UE 110 to perform at least the following or for performing at least the following:
obtaining a plurality of configurations for signals that enable positioning that can be undertaken by a network;
obtaining an indication of an order of preference for the plurality of configurations; and
transmitting one or more requests to a network indicating at least some of the plurality of configurations for signals that enable positioning and the order of preference for the plurality of configurations.

Computer program instructions for causing a network device to perform at least the following or for performing at least the following:
transmitting information indicative of a plurality of configurations for signals that enable positioning that can be undertaken by the network and an indication of an order of preference for the plurality of configurations for signals that enable positioning.

The computer program instructions may be comprised in a computer program, a non-transitory computer readable medium, a computer program product, a machine readable medium. In some but not necessarily all examples, the computer program instructions may be distributed over more than one computer program.

Although the memory 704 is illustrated as a single component/circuitry it may be implemented as one or more separate components/circuitry some or all of which may be integrated/removable and/or may provide permanent/semi-permanent/dynamic/cached storage.

Although the processor 702 is illustrated as a single component/circuitry it may be implemented as one or more separate components/circuitry some or all of which may be integrated/removable. The processor 702 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory (ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The stages illustrated in the FIGS. 2 to 4 can represent steps in a method and/or sections of code in the computer program 706. The illustration of a particular order to the blocks does not necessarily imply that there is a required or preferred order for the blocks and the order and arrangement of the block may be varied. Furthermore, it can be possible for some blocks to be omitted.

Where a structural feature has been described, it may be replaced by means for performing one or more of the functions of the structural feature whether that function or those functions are explicitly or implicitly described.

In some but not necessarily all examples, the UE 110, and the network 100 are configured to communicate data with or without local storage of the data in a memory 704 at the UE 110, or the node apparatus 120 and with or without local processing of the data by circuitry or processors at the UE 110, or the node apparatus 120.

The data may be stored in processed or unprocessed format remotely at one or more devices. The data may be stored in the Cloud.

The data may be processed remotely at one or more devices. The data may be partially processed locally and partially processed remotely at one or more devices.

The data may be communicated to the remote devices wirelessly via short range radio communications such as Wi-Fi or Bluetooth, for example, or over long range cellular radio links. The apparatus may comprise a communications interface such as, for example, a radio transceiver for communication of data.

The UE 110 and the network 100 can be part of the Internet of Things forming part of a larger, distributed network.

The processing of the data, whether local or remote, can be for the purpose of health monitoring, data aggregation, patient monitoring, vital signs monitoring or other purposes.

The processing of the data, whether local or remote, may involve artificial intelligence or machine learning algorithms. The data may, for example, be used as learning input to train a machine learning network or may be used as a query input to a machine learning network, which provides a response. The machine learning network may for example use linear regression, logistic regression, vector support machines or an acyclic machine learning network such as a single or multi hidden layer neural network.

The processing of the data, whether local or remote, may produce an output. The output may be communicated to the UE 110, and the node apparatus 120 where it may produce an output sensible to the subject such as an audio output, visual output or haptic output.

The above described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. A node apparatus comprising:
at least one processor; and
at least one memory including computer program code,
the at least one memory and the computer program code configured to, with the at least one processor,
cause the node apparatus at least to perform:
transmitting information indicative of a plurality of configurations for signals that enable positioning that can be undertaken by the network and an indication of an order of preference for the plurality of configurations.

2. A node apparatus as claimed in claim 1 wherein the node apparatus is configured to receive information indicative of a plurality of configurations for signals that enable positioning that can be undertaken by the network from a network apparatus configured to determine locations of one or more User Equipments (UEs).

3. A node apparatus as claimed in claim 2 wherein the network apparatus configured to determine location of one or more UEs comprises a Location Management Function (LMF).

4. A node apparatus as claimed in claim 2 wherein the node apparatus is configured to receive a request indicating a plurality of configurations for signals that enable positioning that can be undertaken by the network from a network apparatus configured to determine locations of one or more User Equipments (UEs).

5. A node apparatus as claimed in claim 1 wherein the node apparatus is configured to receive information indicative of a plurality of configurations for signals that enable positioning that can be undertaken by the network in a positioning protocol message.

6. A node apparatus as claimed in claim 1 wherein the information indicative of a plurality of configurations for signals that enable positioning that can be undertaken by the network is transmitted by the node apparatus to one or more UEs.

7. A node apparatus as claimed in claim 6 wherein the information indicative of a plurality of configurations for signals that enable positioning that can be undertaken by the network is transmitted by the node apparatus using a Radio Resource Control (RRC) message.

8. A node apparatus as claimed in claim 1 wherein the plurality of configurations for signals that enable positioning comprise configurations that are available at the node apparatus and at one or more neighbouring node apparatus.

9. A node apparatus as claimed in claim 1 wherein the plurality of configurations for signals that enable positioning are determined based on data provided by the node apparatus and one or more neighbouring node apparatus.

10. A node apparatus as claimed in claim 1 wherein the order of preference of the plurality of configurations for signals that enable positioning is configured so as to substantially optimise efficiency of network resources.

11. A node apparatus as claimed in claim 1 wherein the information indicative of a plurality of configurations for signals that enable positioning that can be undertaken by the network and an indication of an order of preference for the plurality of configurations is transmitted at regular intervals.

12. A node apparatus as claimed in claim 1 wherein the information indicative of a plurality of configurations for signals that enable positioning that can be undertaken by the network and an indication of an order of preference for the plurality of configurations is transmitted in response to a trigger event.

13. A node apparatus as claimed in claim 1 wherein the plurality of configurations for signals that enable positioning that can be undertaken by the network are specific to a subset of UEs.

14. A node apparatus as claimed in claim 1 wherein the configurations for signals that enable positioning comprise Positioning Reference Signal (PRS) configurations.

15-16. (canceled)

17. A User Equipment (UE) comprising:
at least one processor; and
at least one memory including computer program code
the at least one memory and the computer program code configured to, with the at least one processor,
cause the UE at least to perform:
obtaining a plurality of configurations for signals that enable positioning that can be undertaken by a network:
obtaining an indication of an order of preference for the plurality of configurations; and
transmitting one or more requests to a network indicating at least some of the plurality of configurations for signals that enable positioning and the order of preference for the plurality of configurations.

18. (canceled)

19. A UE as claimed in claim 17 wherein the UE obtains information indicative of the plurality of configurations for signals that enable positioning that can be undertaken by the network from at least one of: a node apparatus, a network apparatus.

20. (canceled)

21. A UE as claimed in claim 17 wherein the UE generates a list of the plurality of configurations for signals that enable positioning that can be undertaken by the network and the order of preference for the plurality of configurations.

22-23. (canceled)

24. A network apparatus comprising:
at least one processor; and
at least one memory including computer program code,
the at least one memory and the computer program code configured to, with the at least one processor,
cause the network apparatus at least to perform:
transmitting information indicative of a plurality of configurations for signals that enable positioning that can be undertaken by the network and an indication of an order of preference for the plurality of configurations for signals that enable positioning.

25. A network apparatus as claimed in claim 24 wherein the network apparatus receives, from a plurality of node apparatus, data indicative of configurations for signals that enable positioning undertaken by the node apparatus and uses the data indicative of configurations for signals that enable positioning undertaken by the node apparatus to determine the plurality of configurations for signals that enable positioning that can be undertaken by the network and the order of preference for the plurality of configurations for signals that enable positioning.

26. A network apparatus as claimed claim 24 wherein the network apparatus is configured to receive one or more positioning requests from one or more UEs wherein the positioning request indicating at least some of the plurality of configurations for signals that enable positioning and the order of preference for the plurality of configurations.

27-32. (canceled)
